(19) United States
(12) Patent Application Publication
(10) Pub. No.: US 2010/0061007 A1
(43) Pub. Date: Mar. 11, 2010

(54) STORAGE DEVICE AND CONTROL CIRCUIT

(75) Inventors: Hiroki Matsushita, Kawasaki (JP); Yoshinari Higashino, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/569,503

(22) Filed: Sep. 29, 2009

Related U.S. Application Data
(63) Continuation of application No. PCT/JP07/59657, filed on May 10, 2007.

(51) Int. Cl. G11B 5/02

(52) U.S. Cl. 360/68; G9B/5.026

(57) ABSTRACT

According to one embodiment, a storage device includes a rotary actuator, vibration detectors, an analog operation circuit, an analog-to-digital converter, and a rotation vibration compensation controller. The rotary actuator positions a head with respect to a storage medium to perform reading or writing. The vibration detectors are located substantially on both sides of the rotation center of the rotary actuator, detects rotation vibration component of a one-axis direction, and outputs a vibration detection signal. The analog operation circuit calculates a rotation vibration detection signal proportional to rotation vibration disturbance applied to the rotary actuator by differential amplification of the vibration detection signal. The analog-to-digital converter converts the rotation vibration detection signal into a digital signal and outputs rotation vibration detection data. The rotation vibration compensation controller controls the rotation vibration disturbance applied to the rotary actuator to be eliminated based on the rotation vibration detection data.

### CROSS-REFERENCE TO RELATED APPLICATIONS

This application is a continuation of PCT international application Ser. No. PCT/JP2007/059657 filed on May 10, 2007 which designates the United States, incorporated herein by reference.

### BACKGROUND

1. Field

One embodiment of the invention relates to a storage device and a control circuit that position a head with respect to a storage medium by a rotary actuator.

2. Description of the Related Art

In general, when a magnetic disk device is mounted in a rack of a storage system, the magnetic disk device is affected by a vibration of a fan or another disk. This vibration physically vibrates a rotary actuator and appears as disturbance in a head position signal.

As the vibration applied to the magnetic disk device, translational vibration and twisting vibration exist. The translational vibration causes the entire device to move in one direction, and does not affect positioning of the head because the rotary actuator integrally vibrates. Meanwhile, the twisting vibration causes the entire device to move in the rotation direction with an arbitrary position as the center. The twisting vibration causes the rotary actuator rotatably supported by a pivot shaft to move in the rotation direction, and forms disturbance that causes a head positioning error. The twisting vibration is referred to as rotation vibration disturbance.

To compensate for the rotation vibration disturbance, the configuration illustrated in FIG. 13 is used in a conventional technology. In FIG. 13, a rotary actuator 102 rotatably supported by a pivot shaft 101 is provided with respect to a magnetic disk 100 that rotates at a constant speed by a spindle motor. At a front end of the rotary actuator 102, a head 104 is supported.

In a circumferential direction of the magnetic disk 100, servo information is recorded at constant angular intervals. The servo information read by the head 104 is demodulated by a signal processor 106, and a head position is detected by a position detector 108.

If a micro processing unit (MPU) 110 receives a write command or a read command from a host, the MPU 110 outputs a driving signal to a voice coil motor (VCM) 114 by a VCM driver 112 to drive the rotary actuator 102, moves the head 104 to seek a target track, and writes or reads data by the head 104 in an on-track control state in the target track.

In a circuit board of the magnetic disk device, a rotation vibration sensor 115 is provided. The rotation vibration sensor 115 does not perform output with respect to a translational vibration component, and performs output with respect to only a rotation vibration component.

A rotation vibration detection signal detected by the rotation vibration sensor 115 is subjected to signal processing, such as amplification, by a signal processor 116, sampled by an analog-to-digital converter (ADC) 118, and read by the MPU 110.

The MPU 110 calculates a compensation signal that is proportional to the rotation vibration detection signal, adds the compensation signal to a head position signal, drives the voice coil motor 114 by the VCM driver 112, eliminates rotation vibration disturbance applied to the rotary actuator 102, and performs feedforward control for compensating for a head positioning error.

However, in the magnetic disk device according to the conventional technology, the circuit part comprising the rotation vibration sensor, the signal processor, and the ADC needs to be added to compensate for the rotation vibration disturbance. As a result, the manufacturing cost of the magnetic disk device or a process time is increased.

For this reason, a device is known that comprises, instead of the rotation vibration sensor, two inexpensive shock sensors 120-1 and 120-2 to detect only a rotation vibration component of a one-axis direction as illustrated in FIG. 14.

Vibration detection signals output from the shock sensors 120-1 and 120-2 are amplified by amplifiers 122-1 and 122-2, sampled by ADCs 124-1 and 124-2, and read by the MPU 110.

If the vibration detection signals based on the shock sensors 120-1 and 120-2 are defined as V_{SS1} and V_{SS2}, the MPU 110 calculates a compensation signal of rotation vibration disturbance proportional to a difference (V_{SS1}−V_{SS2}) between the vibration detection signals, adds the compensation signal to a head position signal, drives the voice coil motor 114 by the VCM driver 112, eliminates the rotation vibration disturbance applied to the rotary actuator 102, and compensates for a head positioning error. Reference may be had to, for example, Japanese Patent Application Publication (KOKAI) No. S63-213176.

In the detecting circuit of the rotation vibration disturbance illustrated in FIG. 14, the cost of sensors can be reduced by using the shock sensors instead of the rotation vibration sensors. However, since the two shock sensors are provided, two ADCs need to be provided, resulting in an increase in the manufacturing cost.

For this reason, a time-sharing ADC 126 may be provided to the two shock sensors to reduce the cost as illustrated in FIG. 15. For example, the time-sharing ADC 126 sequentially samples vibration detection signals from the shock sensors 120-1 and 120-2 by time-sharing so that the vibration detection signals are to be read by the MPU 110.

However, in the time-sharing ADC 126, the cost is high and the process time is increased twice, which results in increasing a load of the MPU 110 and decreasing a sampling frequency by an AD conversion.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a magnetic disk device according to an embodiment of the invention;

FIG. 2 is an exemplary view of an arrangement of shock sensors with respect to a control board of an internal structure in the embodiment;

FIG. 3 is an exemplary schematic diagram for explaining rotation vibration compensation control according to a first embodiment of the invention;

FIG. 4 is an exemplary circuit block diagram of a rotation vibration detector illustrated in FIG. 3 in the first embodiment;

FIG. 5 is an exemplary schematic diagram for explaining vibration detection by shock sensors when the rotation center of an actuator and the rotation vibration center thereof match in the first embodiment;

FIG. 6 is a flowchart of rotation vibration compensation control in the first embodiment;

FIG. 7 is an exemplary schematic diagram for explaining rotation vibration compensation control according to a second embodiment of the invention;

FIG. 8 is an exemplary circuit block diagram a rotation vibration detector illustrated in FIG. 7 in the second embodiment;

FIG. 9 is an exemplary schematic diagram for explaining vibration detection by shock sensors when the rotation center of an actuator and the rotation vibration center thereof do not match in the second embodiment;

FIG. 10 is a flowchart of rotation vibration compensation control in the second embodiment;

FIG. 11 is an exemplary schematic diagram for explaining rotation vibration compensation control according to a third embodiment of the invention;

FIG. 12 a flowchart of the rotation vibration compensation control in the third embodiment;

FIG. 13 is an exemplary schematic diagram for explaining rotation vibration compensation control according to a conventional technology using a rotation vibration sensor;

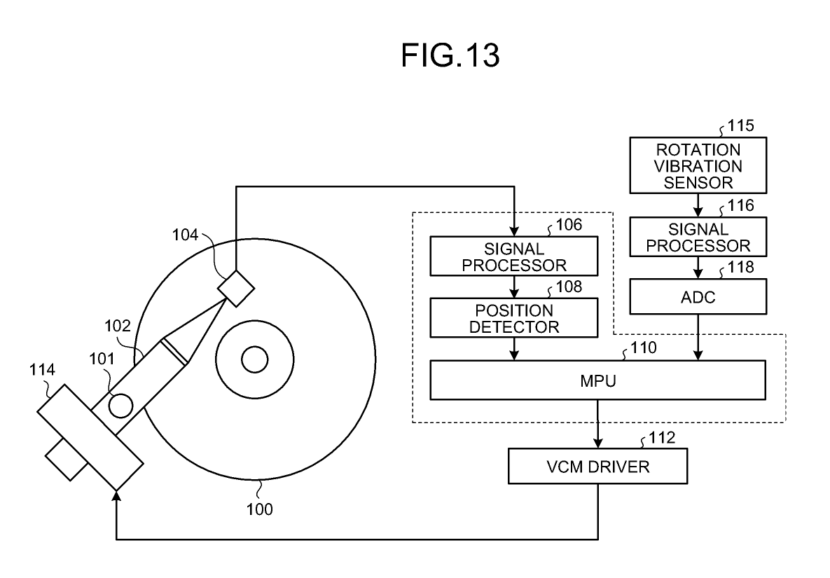

FIG. 14 is an exemplary schematic diagram for explaining rotation vibration compensation control according to a conventional technology using shock sensors instead of the rotation vibration sensor; and

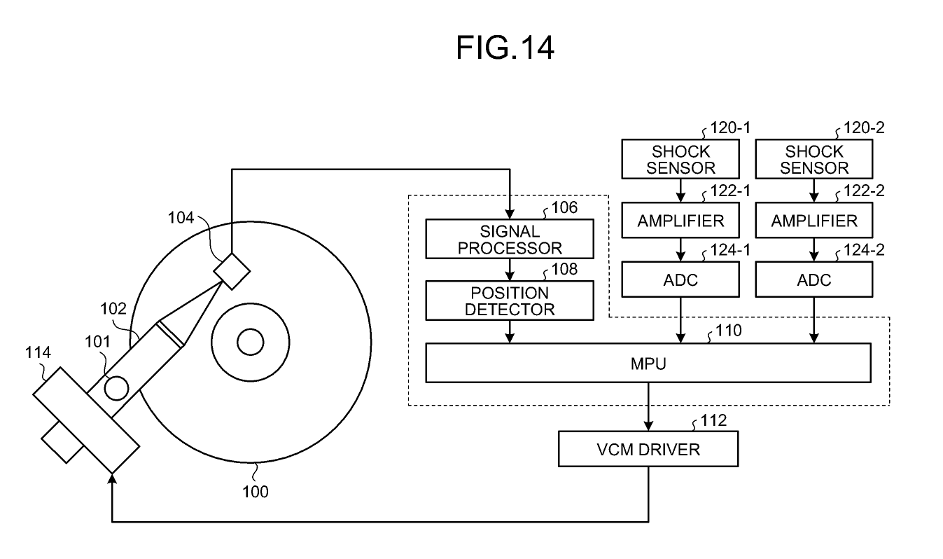

FIG. 15 is an exemplary schematic diagram for explaining the rotation vibration compensation control illustrated in FIG. 14 using time-sharing ADCs in the conventional technology.

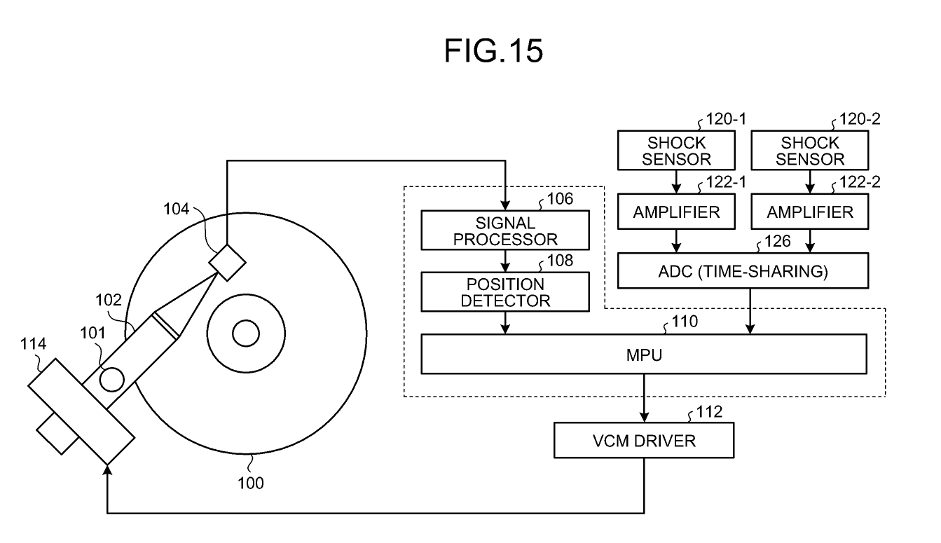

### DETAILED DESCRIPTION

Various embodiments according to the invention will be described hereinafter with reference to the accompanying drawings. In general, according to one embodiment of the invention, a storage device comprises a rotary actuator, a pair of vibration detectors, an analog operation circuit, an analog-to-digital converter, and a rotation vibration compensation controller. The rotary actuator is configured to position a head with respect to a storage medium and cause the head to perform reading operation or writing operation. The vibration detectors are located at positions on the storage device substantially on both sides of the rotation center of the rotary actuator. The vibration detectors are configured to detect rotation vibration component of a one-axis direction and output a vibration detection signal. The analog operation circuit is configured to calculate a rotation vibration detection signal proportional to rotation vibration disturbance applied to the rotary actuator by differential amplification of the vibration detection signal from the vibration detectors and output the rotation vibration detection signal. The analog-to-digital converter is configured to convert the rotation vibration detection signal output from the analog operation circuit into a digital signal and output rotation vibration detection data. The rotation vibration compensation controller is configured to control the rotation vibration disturbance applied to the rotary actuator to be eliminated based on the rotation vibration detection data output from the analog-to-digital converter.

According to another embodiment of the invention, a control circuit is provided in a device comprising a rotary actuator configured to position a head with respect to a storage medium and cause the head to perform reading operation or writing operation. The control circuit comprises a pair of vibration detectors, an analog operation circuit, an analog-to-digital converter, and a rotation vibration compensation controller. The vibration detectors are located at positions on the device substantially on both sides of the rotation center of the rotary actuator. The vibration detectors are configured to detect rotation vibration component of a one-axis direction and output a vibration detection signal. The analog operation circuit is configured to calculate a rotation vibration detection signal proportional to rotation vibration disturbance applied to the rotary actuator by differential amplification of the vibration detection signal from the vibration detectors and output the rotation vibration detection signal. The analog-to-digital converter is configured to convert the rotation vibration detection signal output from the analog operation circuit into a digital signal and output rotation vibration detection data. The rotation vibration compensation controller is configured to control the rotation vibration disturbance applied to the rotary actuator to be eliminated based on the rotation vibration detection data output from the analog-to-digital converter.

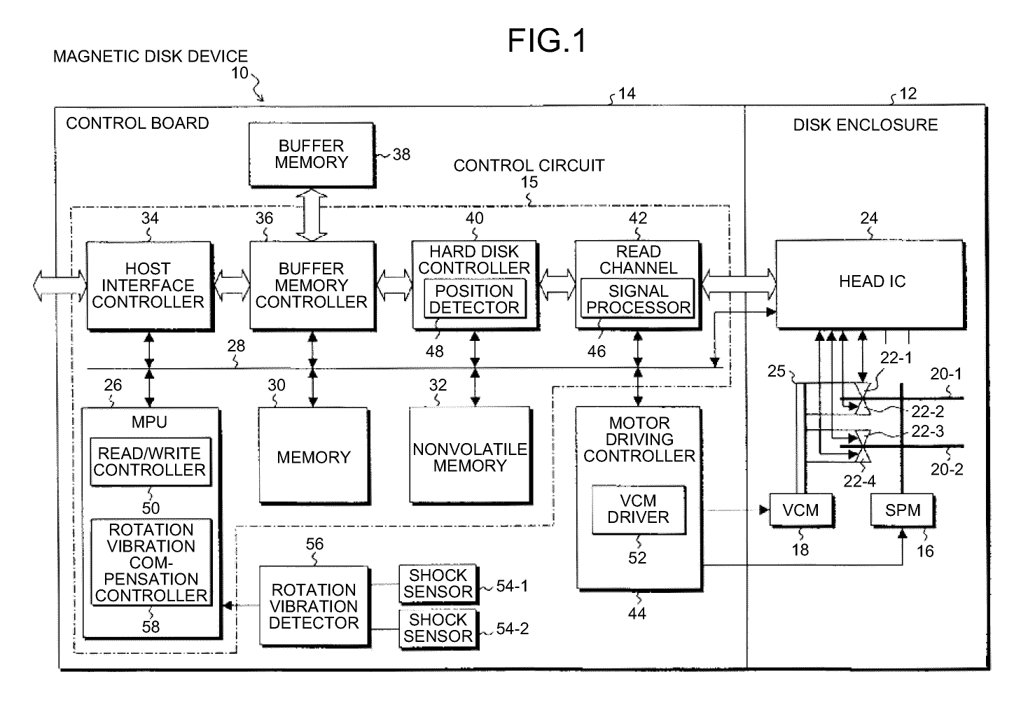

FIG. 1 is a block diagram of a magnetic disk device according to an embodiment of the invention. As illustrated in FIG. 1, a magnetic disk device 10 such as, for example, a hard disk drive (HDD) comprises a disk enclosure 12 and a control board 14. In the disk enclosure 12, a spindle motor (SPM) 16 is provided, and magnetic disks (storage media) 20-1 and 20-2 are mounted on a rotation shaft of the spindle motor 16 and rotate for a constant time, for example, at a rotation speed of 4200 rpm.

Further, in the disk enclosure 12, a voice coil motor (VCM) 18 is provided. The voice coil motor 18 drives a rotary actuator 25, and performs positioning of heads 22-1 to 22-4 supported by a front end of an arm with respect to recording surfaces of the magnetic disks 20-1 and 20-2.

Each of the heads 22-1 to 22-4 is a composite head where a recording element and a reading element are integrated. As the recording element, a recording element of a longitudinal magnetic recording type or a recording element of a vertical magnetic recording type is used. In the case of the recording element of the vertical magnetic recording type, in the magnetic disks 20-1 and 20-2, for example, vertical storage media that comprise a recording layer and a soft magnetic backing layer are used. In the reading element, a GRM element or a TMR element is used.

The heads 22-1 and 22-2 are connected to a head IC 24 through signal lines. The head IC 24 selects one head by a head selection signal based on a read command or a write command from a host, i.e., an upper device and performs a write or read operation. In the head IC 24, a write driver is provided with respect to a write system, and a preamplifier is provided with respect to a read system.

In the control board 14, an MPU 26 is provided. With respect to a bus 28 of the MPU 26, a memory 30 storing a control program and control data using a RAM, and a nonvolatile memory 32 storing a control program using a FROM are provided.

In the bus 28 of the MPU 26, a host interface controller 34, a buffer memory controller 36 controlling a buffer memory 38, a hard disk controller 40 functioning as a format, a read channel 42 functioning as a write modulator and a read demodulator, and a motor driving controller 44 controlling the voice coil motor 18 and the spindle motor 16 are provided.

The MPU 26, the memory 30, the nonvolatile memory 32, the host interface controller 34, the buffer memory controller 36, the hard disk controller 40, and the read channel 42 in the control board 14 constitute a control circuit 15, and are realized as one LSI circuit.

A read/write controller 50 performs writing operation and reading operation according on a command from the host. The same function as the read/write controller 50 may be realized by executing a program by the MPU 26. In this case, the magnetic disk device 10 normally operates in the following manner.

If the host interface controller 34 receives a write command and write data from the host, the write command is decoded by the MPU 26, and the received write data is stored in the buffer memory 38 according to necessity. Then, the write data is converted in a predetermined data format by the hard disk controller 40 and an ECC code is added to the write data by an ECC encoding process. The write data is subjected to scrambling by a write modulating system in the read channel 42, subjected to RLL code conversion, and subjected to write compensation. Then, the write data is written in the magnetic disk 20-1 from the write head of the head 22-1 selected from the write amplifier through the head IC 24.

When the write data is written in the magnetic disk 20-1, a head positioning signal is applied from the MPU 26 to the motor driving controller 44. After moving the head to seek a target track according to a command by the voice coil motor 18 and performing on-track, track following control is performed.

Specifically, in a circumferential direction of the magnetic disk 20-1, servo information is recorded at constant angular intervals, the servo information read by the head 22-1 is demodulated by a signal processor 46 that is provided in the read channel 42, a head position is detected by a position detector 48 that is provided in the hard disk controller 40, a head positioning signal is applied from the read/write controller 50 of the MPU 26 to the motor driving controller 44, and the rotary actuator 25 is rotated by driving the voice coil motor 18 by a VCM driver 52. After moving the head to seek the target track instructed by the command and performing the on-track, the track following control is performed. The position detector 48 may be realized as a function of the MPU 26.

Meanwhile, if the host interface controller 34 receives the read command from the host, the read command is decoded by the MPU 26, the preamplifier amplifies a read signal read from the read head selected by the head select of the head IC 24, the read signal is input to the read demodulating system of the read channel 42, the read data is demodulated by partial response maximum-likelihood (PRML) detection, an ECC decoding process is performed by the hard disk controller 40 to correct an error, the read data is buffered in the buffer memory 38, and the read data is transmitted from the host interface controller 34 to the host.

The control board 14 in the magnetic disk device 10 according to the embodiment includes, to compensate for a head position error due to rotation vibration disturbance applied to the magnetic disk device, a pair of shock sensors 54-1 and 54-2, a rotation vibration detector 56, and a rotation vibration compensation controller 58, the same function of which may be implemented by executing a program by the MPU 26.

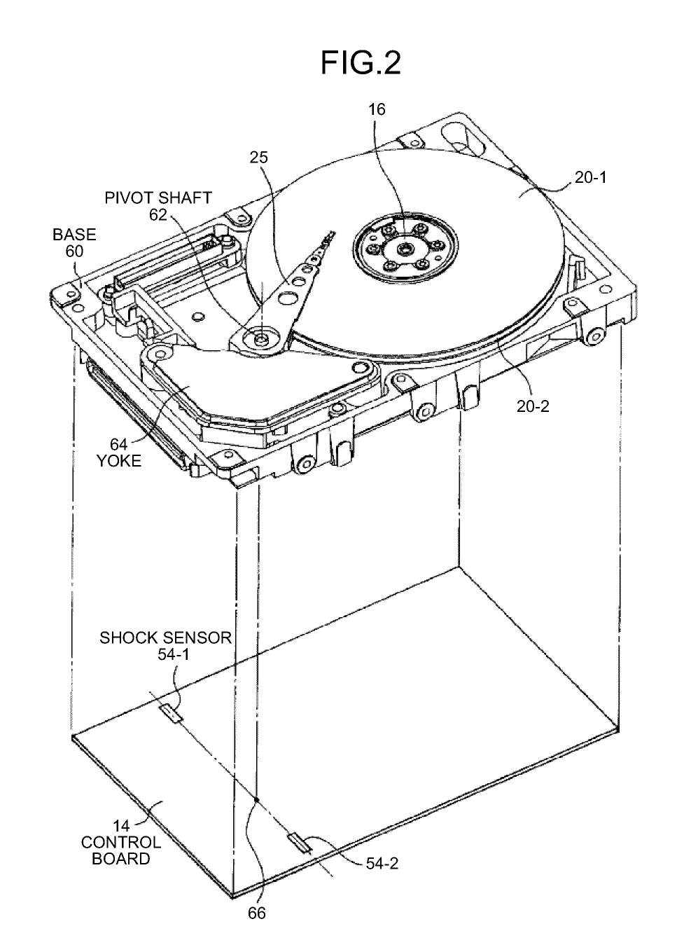

FIG. 2 illustrates the mechanism configuration of the magnetic disk device of the embodiment and arrangement positions of the shock sensors provided on the control board. As illustrated in FIG. 2, in the magnetic disk device of the embodiment, the magnetic disks 20-1 and 20-2 that rotate at a constant speed by the spindle motor 16 are arranged on a base 60.

With respect to the magnetic disks 20-1 and 20-2, the rotary actuator 25 rotatably supported by a pivot shaft 62 is arranged, and supports the head 22-1 at a front end thereof. At the side opposite to the head mounting side of the rotary actuator 25, a coil is provided. The coil is fixed on the base 60 and mounts a permanent magnet, and a coil portion is rotatably positioned between yokes 64 arranged in the vertical direction to constitute the voice coil motor 18.

At the rear side of the base 60, the control board (circuit board) 14 is arranged. As illustrated to be exploded toward the lower side in FIG. 2, the pair of shock sensors 54-1 and 54-2 are arranged on the control board 14. As a material of the shock sensors 54-1 and 54-2, for example, a polyvinylidene fluoride (PVDF) film known as a film piezoelectric sheet is used.

The shock sensors 54-1 and 54-2 detect rotation vibration components of a one-axis direction and output vibration detection signals V_{SS1} and V_{SS2}, respectively. The shock sensors 54-1 and 54-2 are arranged on approximately both sides of the control board with a position 66 therebetween. In this case, a central line that is descended from the pivot shaft 62 of the rotary actuator 25 with respect to the control board 14 passes through the position 66.

In this example, the shock sensors 54-1 and 54-2 are arranged such that a straight line coupling the shock sensors 54-1 and 54-2 passes through the position 66 that the central line from the pivot shaft 62 passes. However, the straight line coupling the shock sensors 54-1 and 54-2 does not necessarily pass through the position 66 that the center of the pivot shaft 62 passes. The shock sensors 54-1 and 54-2 may be arranged on approximately both sides of the control board, with respect to the position 66 corresponding to the central line of the pivot shaft 62.

Referring back to FIG. 1, the vibration detection signals detected by the shock sensors 54-1 and 54-2 are input to the rotation vibration detector 56. In the rotation vibration detector 56, an analog operation circuit is provided, as will be described in detail later. By the differential amplification of the vibration detection signals output from the shock sensors 54-1 and 54-2, the rotation vibration detection signals corresponding to the rotation vibration disturbance signals applied to the rotary actuator 25 are calculated and output. The rotation vibration detection signals are sampled by an analog-to-digital converter (ADC) and read by the MPU 26.

The rotation vibration compensation controller 58 in the MPU 26 adds a compensation signal to the head position signal to eliminate the rotation vibration disturbance applied to the rotary actuator 25, based on rotation vibration detection data sampled by the ADC provided in the rotation vibration detector 56.

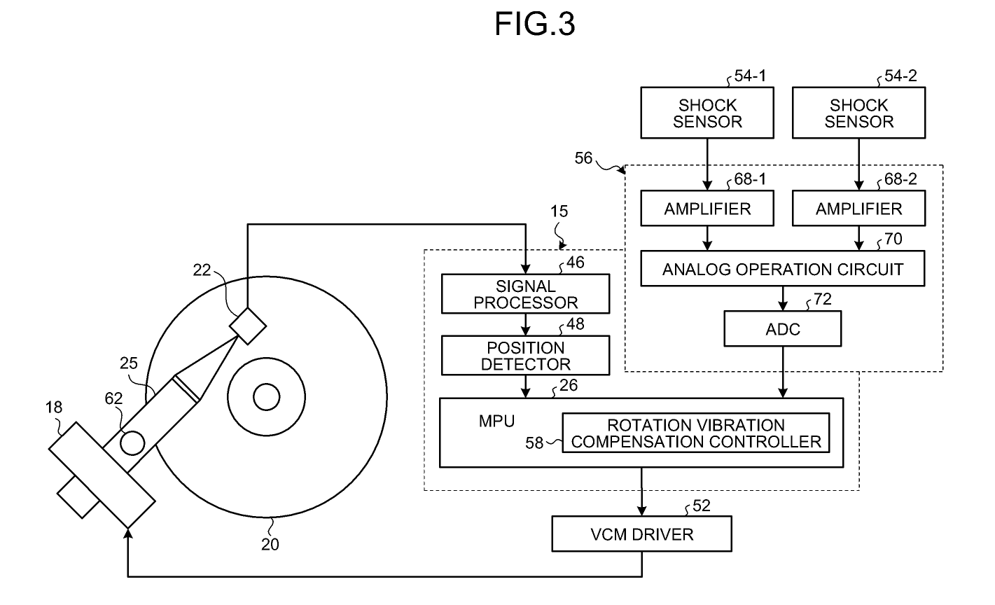

FIG. 3 illustrates rotation vibration compensation control according to a first embodiment of the invention. In FIG. 3, a servo signal on the magnetic disk 20 detected by the head 22 is demodulated by the signal processor 46, the servo signal is converted into a head position signal by the position detector 48 and read by the MPU 26, and the head 22 is moved to seek a desired track and the on-track is performed. In this state, to eliminate an error of the head position signal with respect to the target position, i.e., an error with respect to the center of the track, the MPU 26 drives the voice coil motor 18 by the VCM driver 52, and performs on-track control to move the head 22 to the center of the target track by the rotary actuator 25.

To perform rotation vibration compensation control with respect to the on-track control of the head 22, the shock sensors 54-1 and 54-2, the rotation vibration detector 56, and the rotation vibration compensation controller 58 are provided. In the rotation vibration detector 56, amplifiers 68-1 and 68-2, a high-speed analog operation circuit 70, and an ADC 72 are provided.

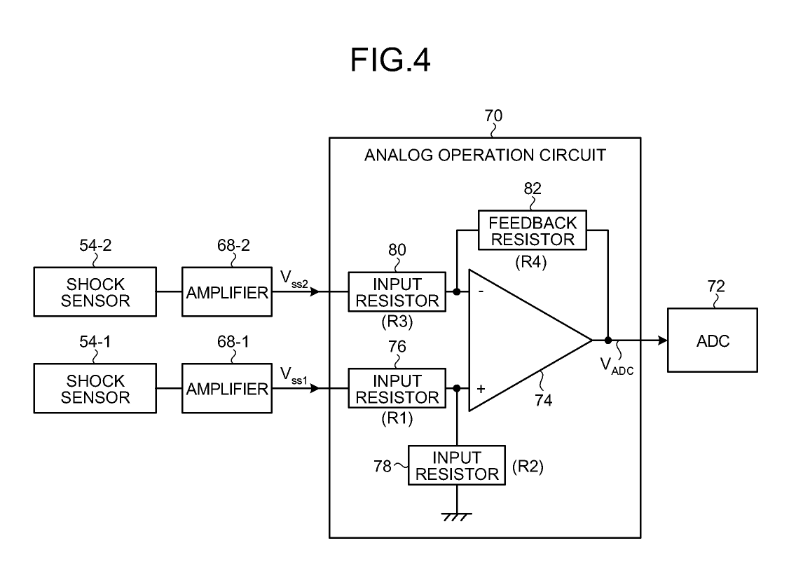

FIG. 4 is a circuit block diagram of the rotation vibration detector 56 of the first embodiment. In FIG. 4, the output of the shock sensors 54-1 and 54-2 are amplified by the amplifiers 68-1 and 68-2 and are input as vibration detection signals V_{SS1} and V_{SS2} to the analog operation circuit 70. The analog operation circuit 70 constitutes a differential amplifying circuit comprising an operational amplifier 74 of differential amplification type, three input resistors 76, 78, and 80, and a feedback resistor 82.

The analog operation circuit 70 outputs a rotation vibration detection signal V_{ADC} Proportional to a differential signal (V_{SS1}−V_{SS2}) of the vibration detection signals V_{SS1} and V_{SS2} of the shock sensors 54-1 and 54-2 input through the amplifiers 68-1 and 68-2 to the ADC 72 to be sampled by the ADC 72, and the rotation vibration detection signal is read as rotation vibration detection data by the rotation vibration compensation controller 58 of the MPU 26 of FIG. 3.

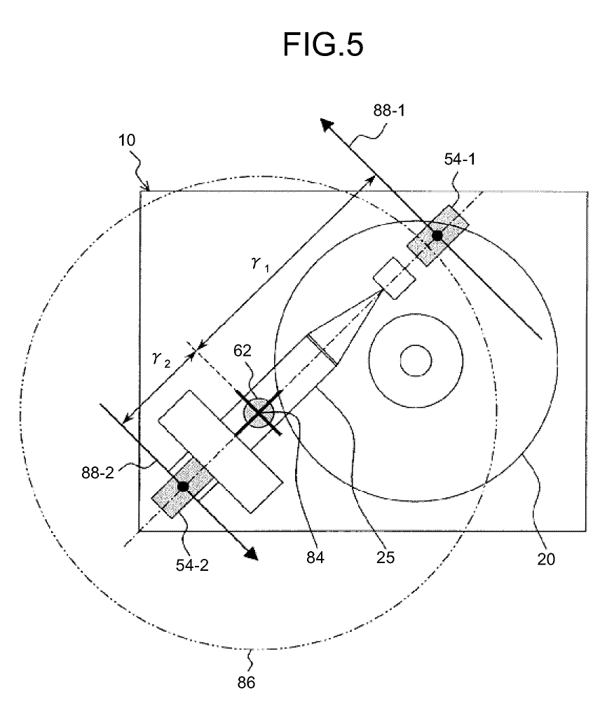

FIG. 5 illustrates vibration detection using shock sensors when the rotation center of a rotary actuator and the rotation vibration center thereof match.

In FIG. 5, the rotation center of the rotary actuator 25 is the pivot shaft 62, and a center 84 of a rotation vibration 86 caused due to external vibration also matches the pivot shaft 62. In this case, the shock sensors 54-1 and 54-2 are arranged at positions on both sides of the straight line passing through the center 84 of the rotation vibration 86, which are spaced apart from the center by the distances r₁ and r₂. The arrows 88-1 and 88-2 indicate acceleration directions.

Actually, as illustrated in FIG. 2, the shock sensors 54-1 and 54-2 are arranged parallel to the short side of the control board 14. However, if the distances from the position 66 through which the vertical line from the pivot shaft 62 pass to the shock sensors 54-1 and 54-2 are defined as r₁ and r₂, the arrangement positions in this case are the same as that in the case of FIG. 5 that equivalently illustrates the shock sensors 54-1 and 54-2 according to the direction of the rotary actuator 25.

As illustrated in FIG. 5, when it is assumed that the rotation vibration center and the rotation center of the actuator match, the rotation vibration detection signal V_{Rerr} is given by the following Equation:

$${V}_{Rerr} ∝ ( \frac{{V}_{ss 1}}{{r}_{1}} - \frac{{V}_{ss 2}}{{r}_{2}} ) \qquad ( 1 )$$

where V_{SS1} and V_{SS2} are sensor outputs and r₁ and r₂ are distances from the rotation center of the actuator to the sensors.

In Equation (1), the reason why the sensor outputs V_{SS1} and V_{SS2} are divided by the distances r₁ and r₂ is to normalize the sensor outputs to values not depending on the distances.

In the analog operation circuit of the first embodiment, an output signal V_{ADC} as a rotation vibration detection signal is given by the following Equation:

$${V}_{ADC} = \frac{{R}_{3} + {R}_{4}}{{R}_{1} + {R}_{2}} \times ( \frac{{R}_{2}}{{R}_{3}} {V}_{ss 1} - \frac{{R}_{4}}{{R}_{3}} {V}_{ss 2} ) \qquad ( 2 )$$

where V_{SS1} and V_{SS2} are sensor outputs, and R₁ to R₄ are values of the input resistors and the feedback resistor.

In Equation (2), R₁ to R₄ are set to satisfy Equation (1).

In this case, if Equation (4) is transformed, the following Equation is obtained:

$${V}_{ADC} = \frac{{V}_{ss 1}}{\frac{( {R}_{1} + {R}_{2} ) {R}_{3}}{( {R}_{3} + {R}_{4} ) {R}_{2}}} - \frac{{V}_{ss 2}}{\frac{( {R}_{1} + {R}_{2} ) {R}_{3}}{( {R}_{3} + {R}_{4} ) {R}_{4}}} \qquad ( 3 )$$

Accordingly, in Equation (1), r₁ and r₂ are given by the following Equations:

$$\begin{matrix}{r}_{1} = \frac{( {R}_{1} + {R}_{2} ) {R}_{3}}{( {R}_{3} + {R}_{4} ) {R}_{2}} & ( 4 ) \\ {r}_{2} = \frac{( {R}_{1} + {R}_{2} ) {R}_{3}}{( {R}_{3} + {R}_{4} ) {R}_{4}} & ( 5 )\end{matrix}$$

In this case, r₁ and r₂ are obtained as constants that provide the distances from the rotation center of the actuator to the sensors. If the two resistances among the resistances R₁ to R₄ of the analog operation circuit, for example, the resistances R₁ and R₂ are determined as the circuit constants, the resistances R3 and R4 that satisfy Equation (1) can be calculated by substituting r1, r2, R1, and R2 for Equations (4) and (5).

Meanwhile, if 1/r₁ and 1/r₂ in Equation (1) are represented by sensor-side gains G₁ and G₂ in the analog operation circuit, Equation (3) can be replaced by the following Equation:

V_{ADC}=(G₁×Vₛₛ₁)−(G₂×Vₛₛ₂) (6)

For this reason, the analog operation circuit can obtain the difference between the sensor outputs V_{SS1}×G₁ and V_{SS2}×G₂ after multiplying the sensor outputs V_{SS1} and V_{SS2} by the gains G₁ and G₂.

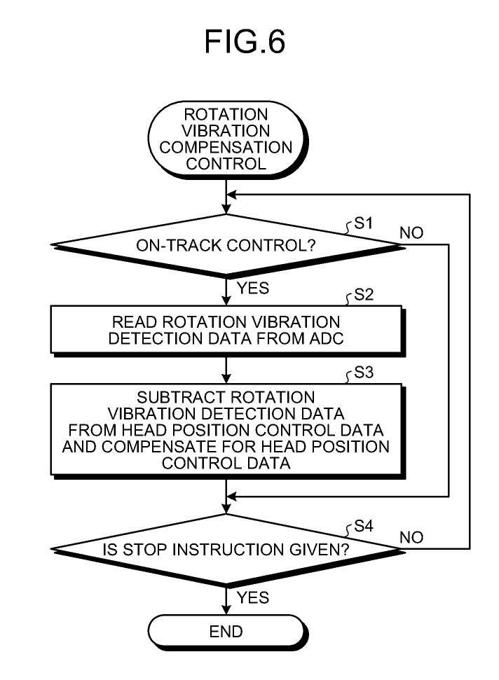

FIG. 6 is a flowchart of rotation vibration compensation control according to the first embodiment. First, as illustrated in FIG. 6, the rotation vibration compensation controller 58 in the MPU 26 determines whether the control is the on-track control after the completion of seeking with respect to the target track at S1. If the MPU 26 determines the control as the on-track control, the process proceeds to S2, and the MPU 26 reads the rotation vibration detection data sampled by the ADC 72 in the rotation vibration detector 56.

As given by Equation (2), the rotation vibration detection data is a value proportional to the difference (V_{SS1}−V_{SS2}) of the output signals V_{SS1} and V_{SS2} of the shock sensors 54-1 and 54-2 calculated by the analog operation circuit 70 illustrated in FIG. 4.

Next, at S3, after subtraction of the read rotation vibration detection data from the calculated head position control data, feedforward control that performs a DA conversion on the head position control data by the VCM driver 52 and outputs the data is performed. As a result, the compensation control is performed to eliminate the rotation vibration component applied to the rotary actuator 25. The process from S1 to S3 is repeated until the stop instruction is given at S4.

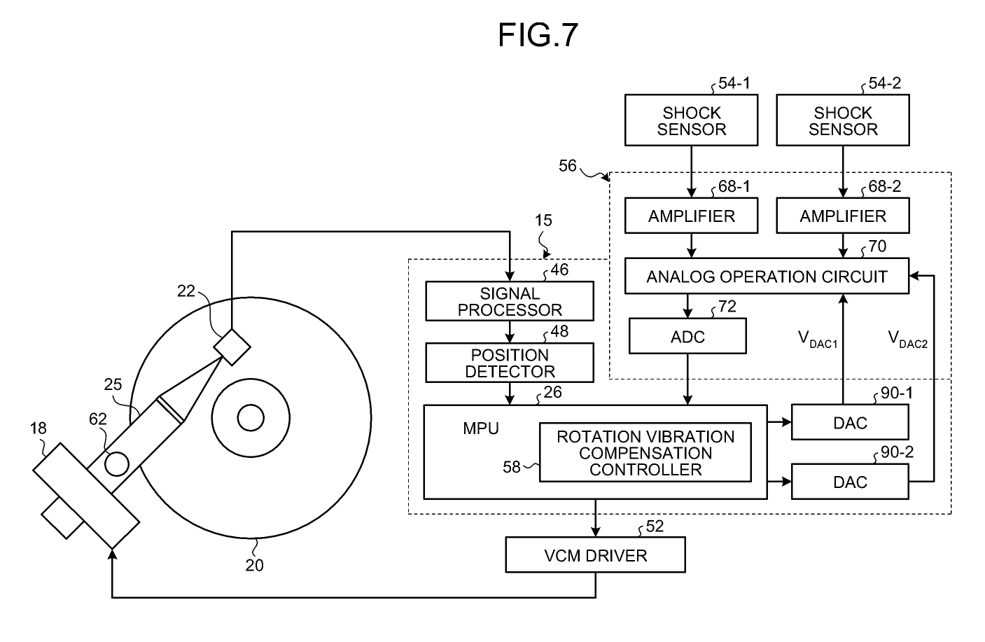

FIG. 7 illustrates rotation vibration compensation control according to a second embodiment of the invention. As illustrated in FIG. 7, the control circuit 15 comprises digital-to-analog converters (DACs) 90-1 and 90-2 in addition to the signal processor 46, the position detector 48, and the MPU 26.

Meanwhile, the rotation vibration detector 56 comprises, similarly to that of the first embodiment illustrated in FIG. 3, amplifiers 68-1 and 68-2 to amplify vibration detection signals from the shock sensors 54-1 and 54-2, the analog operation circuit 70 to perform a differential operation, and the ADC 72. However, output signals V_{DAC1} and V_{DAC2} from the DACs 90-1 and 90-2 in the control circuit 15 are input to the analog operation circuit 70.

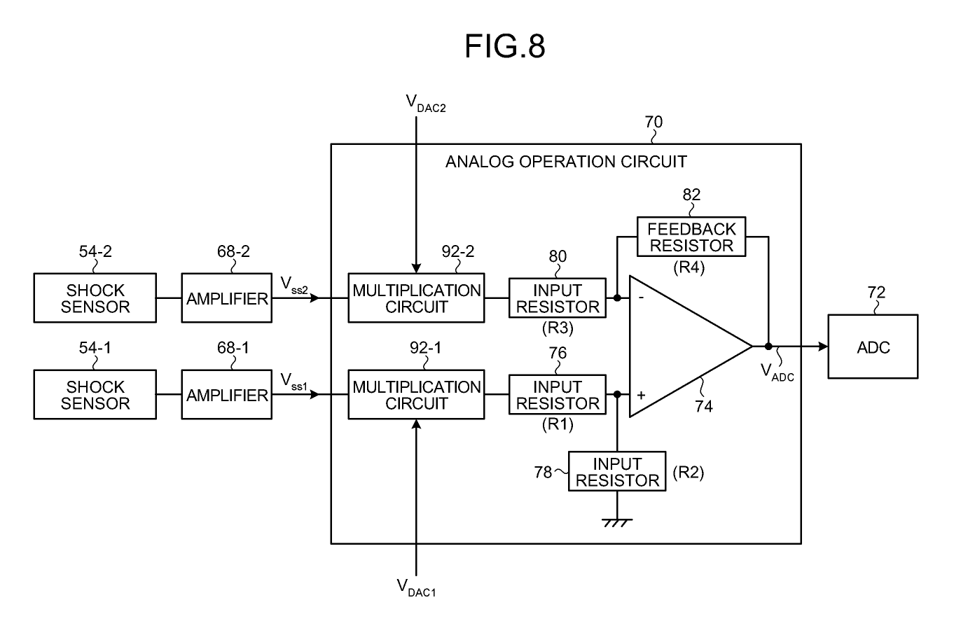

FIG. 8 is a circuit diagram of the rotation vibration detector 56 of the second embodiment. As illustrated in FIG. 8, the circuit part comprising the shock sensors 54-1 and 54-2, the amplifiers 68-1 and 68-2, and the operational amplifier 74, the input resistors 76, 78, and 80, and the feedback resistor 82 provided in the analog operation circuit 70 is the same as that illustrated in FIG. 4. However, in the second embodiment, multiplication circuits 92-1 and 92-2 are provided between the amplifiers 68-1 and 68-2 and the input resistor 76 with respect to a non-inverting input terminal (+) of the operational amplifier 74 and the input resistor 80 with respect to an inverting input terminal (−).

The multiplication circuits 92-1 and 92-2 multiply the vibration detection signals V_{SS1} and V_{SS2} output from the amplifiers 68-1 and 68-2 by the output signals V_{DAC1} and V_{DAC2} indicating predetermined adjustment gains output from the MPU 26 of the second embodiment and converted into the analog signals by the DACs 90-1 and 90-2, input the signals (V_{SS1}×V_{DAC1}) and (V_{SS2}×V_{DAC2}) to the operational amplifier 74, perform a differential operation determined by the resistors, and output the rotation vibration detection signals.

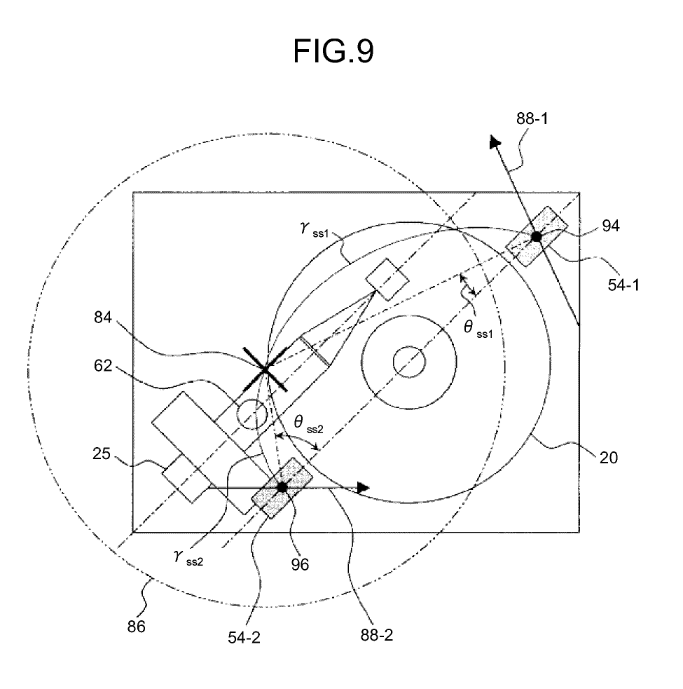

While it is assumed in the first embodiment that the rotation center of the actuator and the rotation vibration center match as illustrated in FIG. 5, in the second embodiment, as illustrated in FIG. 9, the rotation vibration detecting process is performed with respect to the case where the rotation center 84 of the rotation vibration 86 does not match the pivot shaft 62 as the rotation center of the rotary actuator 25. In the actual magnetic disk device, as illustrated in FIG. 9, the rotation vibration center does not generally match the center of the rotary actuator.

As described above, when the rotation center of the rotary actuator and the rotation vibration center do not match, as illustrated in FIG. 5, the rotation vibration detection signal V_{ADC} of the analog operation circuit 70, which is given by Equation (6) and calculated on the assumption that the rotation center of the actuator is matched with the rotation vibration center, cannot be used as it is. By multiplying the gains G_{DAC1} and G_{DAC2} to adjust the displacement of the rotation center illustrated in FIG. 9, Equation (6) needs to be transformed into the following Equation:

V_{ADC}=(G₁×Vₛₛ₁×G_{DAC1})−(G₂×Vₛₛ₂×G_{DAC2}) (7)

Accordingly, in the second embodiment illustrated in FIG. 8, the rotation vibration is detected based on Equation (7).

A description will be given of the detection of the rotation vibration by the shock sensors 54-1 and 54-2 when the rotation vibration center and the center of the rotary actuator do not match as illustrated in FIG. 9.

The output signal V_{SS} of the shock sensor is proportional to the variation in force F applied to the sensor of a tangential direction. The variation in the force F is proportional to a third-order differentiation of the displacement x of the tangential direction, i.e., the variation in the acceleration, and the output signal V_{SS} is represented by the following Equation:

V_{SS}∞\dot{F}=m [symbol] (8)

where m is the mass of the device.

If the third-order differentiation of the displacement x of the tangential direction at the right side of Equation (8) is represented by the displacement (x, y) of the position in the tangential direction in the two-dimensional plane of the shock sensor and also is represented by the variation of the angular speed ω with respect to the rotation vibration center, this is given as the variation in the angular acceleration by the following Equation:

$$\frac{{d}^{3} x}{d {t}^{3}} \frac{{d}^{3} y}{d {t}^{3}} = r \frac{{d}^{3} θ}{d {t}^{3}} = r \frac{{d}^{2} ω}{d {t}^{2}} \qquad ( 9 )$$

Next, the output signals V_{SS1} and V_{SS2} of the shock sensors 54-1 and 54-2 of FIG. 9 are calculated. First, the distances rₛₛ₁ and rₛₛ₂ from the rotation vibration center 84 to the positions 94 and 96 of the shock sensors 54-1 and 54-2 are given by the following Equations:

rₛₛ₁=(Y−Yₛₛ₁)sin θₛₛ₁+(X−Xₛₛ₁)cos θₛₛ₁ (10)

rₛₛ₂=(Y−Yₛₛ₂)sin θₛₛ₂+(X−Xₛₛ₂)cos θₛₛ₂ (11)

where (X, Y) are the coordinates of the rotation vibration center 84, (X_{SS1}, Y_{SS1}) and (X_{SS2}, Y_{SS2}) are the coordinates of positions 94 and 96 of the shock sensors 54-1 and 54-2, and θ_{SS1} and θ_{SS2} are angles of the straight line coupling the rotation vibration center 84 with respect to the straight line coupling the shock sensors 54-1 and 54-2.

The output signals V_{SS1} and V_{SS2} of the shock sensors 54-1 and 54-2 are proportional to the Equation (9), and can be represented by the following Equations:

$$\begin{matrix}{V}_{ss 1} ∝ \frac{{d}^{2} ω}{d {t}^{2}} {G}_{ss 1} {r}_{ss 1} = \frac{{d}^{2} ω}{d {t}^{2}} {G}_{ss 1} [ \begin{matrix}( Y - {Y}_{ss 1} ) sin {θ}_{ss 1} + \\ ( X - {X}_{ss 1} ) cos {θ}_{ss 1}\end{matrix} ] & ( 12 ) \\ {V}_{ss 2} ∝ \frac{{d}^{2} ω}{d {t}^{2}} {G}_{ss 2} {r}_{ss 2} = \frac{{d}^{2} ω}{d {t}^{2}} {G}_{ss 2} [ \begin{matrix}( Y - {Y}_{ss 2} ) sin {θ}_{ss 2} + \\ ( X - {X}_{ss 2} ) cos {θ}_{ss 2}\end{matrix} ] & ( 13 )\end{matrix}$$

The rotation vibration detection component V_{Rerr} applied to the rotary actuator 25 is proportional to (V_{SS1}−V_{SS2}). If Equations (12) and (13) are substituted, this is represented by the following Equation:

$$\begin{matrix}{V}_{Rerr} ∝ ( {V}_{ss 1} - {V}_{ss 2} ) = \frac{{d}^{2} ω}{d {t}^{2}} {G}_{ss 1} [ \begin{matrix}( Y - {Y}_{ss 1} ) sin {θ}_{ss 1} + \\ ( X - {X}_{ss 1} ) cos {θ}_{ss 1}\end{matrix} ] \\ = \frac{{d}^{2} ω}{d {t}^{2}} {G}_{ss 2} [ \begin{matrix}( Y - {Y}_{ss 2} ) sin {θ}_{ss 2} + \\ ( X - {X}_{ss 2} ) cos {θ}_{ss 2}\end{matrix} ]\end{matrix} \qquad ( 14 )$$

Since Equation (14) comprises the rotation vibration center coordinates (X, Y), Equation (14) depends on the rotation vibration center.

The output signal V_{ADC} of the analog operation circuit 70 used for compensating for the rotation vibration is calculated by normalizing Equation (14) by the distances rₛₛ₁ and rₛₛ₂ from the rotation vibration center 84 to the shock sensors 54-1 and 54-2. However, in the second embodiment, at the time of the normalization, the distances r₁ and r₂ in the case of FIG. 5 where the rotation centers match are used, instead of the distances rₛₛ₁ and rₛₛ₂ of FIG. 9.

For this reason, the output signal V_{ADC} of the analog operation circuit obtained by normalizing Equation (14) by the distances r₁ and r₂ of FIG. 3 is incorrect, and needs to be adjusted by multiplying the gains G_{DAC1} and G_{DAC2} as represented by Equation (7).

As illustrated in FIG. 5, if the rotation vibration center 84 and the rotation center of the rotary actuator 25 match, the condition θ_{SS1}=θ_{SS2}=0° is satisfied, and Equation (14) is replaced by the following Equation:

$${V}_{Rerr} ∝ ( {V}_{ss 1} - {V}_{ss 2} ) = \frac{{d}^{2} ω}{d {t}^{2}} {G}_{ss 1} [ ( X - {X}_{ss 1} ) ] - \frac{{d}^{2} ω}{d {t}^{2}} {G}_{ss 2} [ ( X - {X}_{ss 2} ) ] \qquad ( 15 )$$

If Equation (15) is normalized by the distances r₁ and r₂ from the rotation center to the sensors to calculate the output signal of the output signal V_{ADC} of the analog operation circuit, the following Equation is obtained:

$$\begin{matrix}{V}_{ADCr} = \frac{{d}^{2} ω}{d {t}^{2}} {G}_{ss 1} [ ( X - {X}_{ss 1} ) ] / {r}_{1} - \frac{{d}^{2} ω}{d {t}^{2}} {G}_{ss 2} [ ( X - {X}_{ss 2} ) ] / {r}_{2} \\ = {V}_{ss 1} / {r}_{1} - {V}_{ss 2} / {r}_{2}\end{matrix} \qquad ( 16 )$$

Since Equation (16) comprises the rotation vibration center coordinates (X, Y), Equation (16) depends on the rotation vibration center.

Meanwhile, if the conditions G_{SS1}=G_{SS2}−=G and θ_{SS1}=θ_{SS2}=θ are set with respect to Equation (14) in the case where the rotation vibration center 84 of FIG. 9 and the center of the rotary actuator do not match, Equation (14) can be simplified as follows:

$${V}_{Rerr} ∝ ( {V}_{ss 1} - {V}_{ss 2} ) = \frac{{d}^{2} ω}{d {t}^{2}} G [ \begin{matrix}( - {X}_{ss 1} + {X}_{ss 2} ) cos θ + \\ ( - {Y}_{ss 1} + {Y}_{ss 2} ) sin θ\end{matrix} ] \qquad ( 17 )$$

Equation (17) does not comprise the rotation vibration center coordinates (X, Y). Accordingly, this indicates that the rotation vibration component can be detected without depending on the rotation vibration center.

As illustrated in FIG. 5, with respect to Equation (17), if the rotation vibration center and the rotation center of the actuator are set to match, the following Equation is obtained from θ=0°:

$${V}_{Rerr} ∝ ( {V}_{ss 1} - {V}_{ss 2} ) = \frac{{d}^{2} ω}{d {t}^{2}} G [ ( - {X}_{ss 1} + {X}_{ss 2} ) ] \qquad ( 18 )$$

If Equation (18) is normalized by the distances r₁ and r₂ from the rotation center to the sensors to calculate the output signal of the output signal V_{ADC} of the analog operation circuit, the following Equation is obtained:

$$\begin{matrix}{V}_{ADCr} = \frac{{d}^{2} ω}{d {t}^{2}} G [ ( - {X}_{ss 1} / {r}_{1} ) + ( {X}_{ss 2} / {r}_{2} ) ] \\ = {V}_{ss 1} / {r}_{1} - {V}_{ss 2} / {r}_{2}\end{matrix} \qquad ( 19 )$$

Equation (19) is equivalent to a relational expression in the case of FIG. 5. From this relation, the analog operation circuit 70 of the first embodiment illustrated in FIG. 4 can calculate the rotation vibration detection signal V_{ADC} without depending on the rotation vibration center.

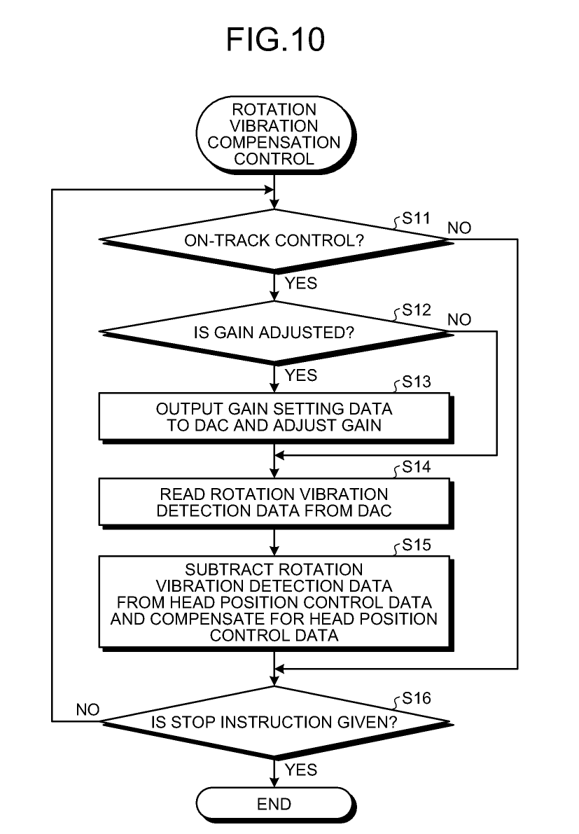

FIG. 10 is a flowchart of rotation vibration compensation control according to the second embodiment. As illustrated in FIG. 10, the rotation vibration compensation controller 58 in the MPU 26 of the second embodiment determines whether the control is the on-track control after the completion of seeking with respect to the target track at S11. If the rotation vibration compensation controller 58 determines the control as the on-track control, the process proceeds to S12, and the rotation vibration compensation controller 58 checks whether the gain adjustment is made with respect to the rotation vibration detection, i.e., the detection of the rotation vibration based on Equation (7) is performed.

If the gain adjustment is set, the process proceeds to S13. The rotation vibration compensation controller 58 outputs gain setting data applying the predetermined adjustment gain to the DACs 90-1 and 90-2, and outputs the gain setting data as gain setting signals V_{DAC1} and V_{DAC2} to the multiplication circuits 92-1 and 92-2 in the analog operation circuit 70 illustrated in FIG. 8.

Accordingly, in the analog operation circuit 70 of FIG. 8, as represented by Equation (7), the differential signal obtained by multiplying the vibration detection signals V_{SS1} and V_{SS2} detected by the shock sensors 54-1 and 54-2 by the gains G₁ and G₂ determined by the input resistors and the feedback resistor with respect to the operational amplifier 74 and the modulation gains G_{DAC1} and G_{DAC2} set by the MPU 26 is output as the rotation vibration detection signal V_{ADC}. The output signal is sampled by the ADC 72 at S14 and read as the rotation vibration detection data.

Next, at S15, the read rotation vibration detection data is subtracted from the head position control data, the compensation control for eliminating the rotation vibration applied to the rotary actuator is performed, and this process is repeated until the stop instruction is given at S16.

According to the second embodiment, the adjustment gains G_{DAC1} and G_{DAC2} are set in the analog operation circuit 70. Specifically, in the state where the magnetic disk device is mounted on a casing such as a rack and external vibration by a fan is applied, it is checked whether a displacement error of the head is generated due to the rotation vibration. When the displacement error of the head is generated, the MPU 26 sets the adjustment gains G_{DAC1} and G_{DAC2} as a predetermined minimum initial value to eliminate the displacement error. When the displacement error of the head is generated again with the set initial value, the MPU 26 sequentially increases the adjustment gains G_{DAC1} and G_{DAC2} to determine optimal adjustment gains.

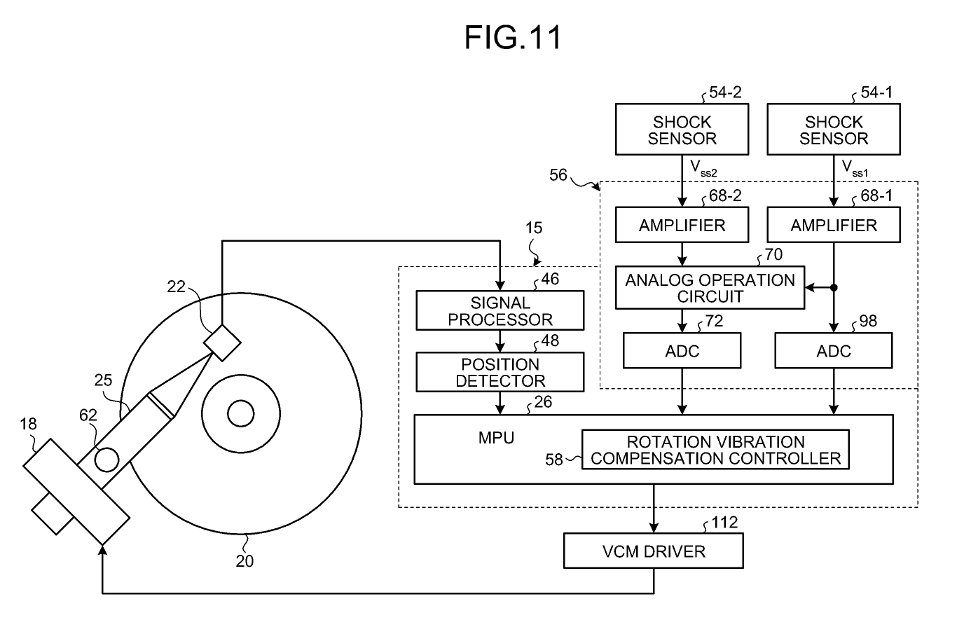

FIG. 11 illustrates rotation vibration compensation control according to a third embodiment of the invention. In the third embodiment, when the displacement error of the head is generated, it is checked whether a translational vibration component is comprised in the rotation vibration detection signal. If the translational vibration component is comprised, the rotation vibration compensation control is cut or the compensation amount is reduced.

In the third embodiment, as illustrated in FIG. 2, the shock sensors 54-1 and 54-2 are arranged with the pivot shaft 62 being the rotation center of the rotary actuator 25 therebetween. The difference between the vibration detection signals is calculated, a signal component by the translational vibration applied to the entire device in one direction, i.e., the translational vibration detection signals having the same polarity generated in the shock sensors 54-1 and 54-2 are offset. The difference is calculated to extract rotation vibration detection signals that are signals having the reverse polarity generated in the shock sensors 54-1 and 54-2.

However, when the shock sensors 54-1 and 54-2 are arranged are unstable places on a printed board such as the control board 14, even in the translational vibration applied to the entire device, the rotation vibration component may be generated in the shock sensors 54-1 and 54-2.

In this case, even if the rotation vibration is not generated, the rotation vibration is detected and the rotation vibration compensation control is performed. As a result, the compensation control provides excessive compensation, and the performance of the magnetic disk device is lowered.

Accordingly, in the third embodiment, when the displacement error of the head is generated, it is determined whether the translational vibration component is detected. When the translational vibration component is detected, the unnecessary compensation control of the rotation vibration is not performed or suppressed.

In FIG. 11, as in the first embodiment, in the rotation vibration detector 56, the amplifiers 68-1 and 68-2 are provided to correspond to the shock sensors 54-1 and 54-2, and the rotation detection signals V_{SS1} and V_{SS2} obtained from the amplifiers 68-1 and 68-2 are input to the analog operation circuit 70.

The analog operation circuit 70 is the same differential amplifying circuit as that illustrated FIG. 4. The analog operation circuit 70 outputs a signal proportional to the differential signal as the rotation vibration detection signal V_{ADC} and samples the signal by the ADC 72, and the signal is read by the rotation vibration compensation controller 58 of the MPU 26.

In the third embodiment, an ADC 98 is provided in the rotation vibration detector 56, only the vibration detection signal Vₛₛ₁ output from the shock sensor 54-1 obtained through the amplifier 68-1 is sampled by the ADC 98 and is read by the MPU 26.

In the rotation vibration compensation controller 58 of the third embodiment, when the displacement error of the head 22 is detected during the compensation control for eliminating the rotation vibration disturbance applied to the rotary actuator 25, based on the sampling of the rotation vibration detection data from the ADC 72 that functions as the first ADC, the translational vibration disturbance component is calculated using the rotation vibration detection data from the shock sensor 54-1 read from the ADC 98 functioning as the second ADC.

Upon calculating the translational vibration disturbance component, a translational disturbance component (V_{SS1}+V_{SS2}) being an addition component of the shock sensors 54-1 and 54-2 is calculated by Equation—(V_{SS1}−V_{SS2})+2×(V_{SS1}) regarding the rotation vibration detection data V_{ADC} sampled by the ADC 72 as the differential data (V_{SS1}−V_{SS2}) of the vibration detection signals of the shock sensors 54-1 and 54-2 and using the vibration detection data V_{SS1} of only the shock sensor 54-1 sampled by the ADC 98.

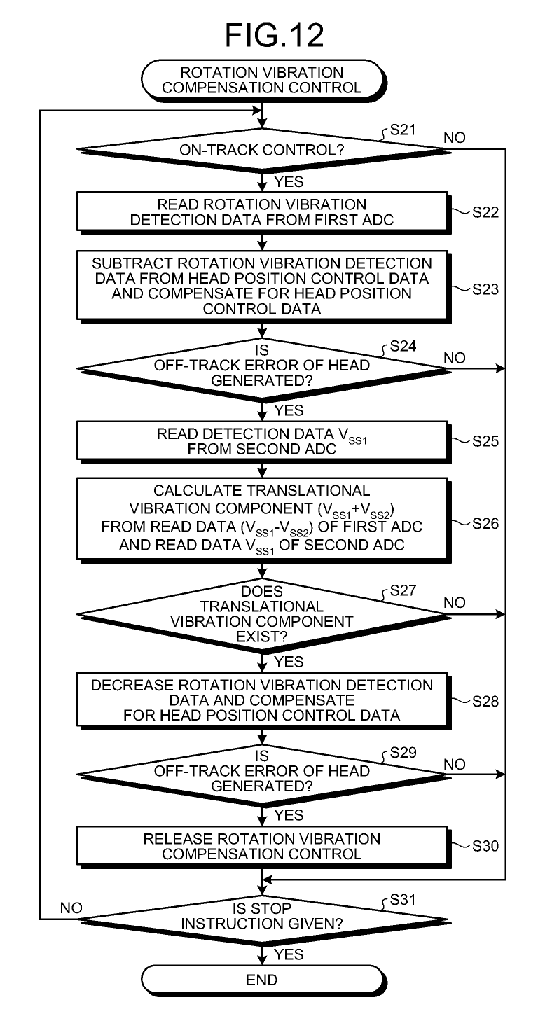

FIG. 12 is a flowchart of rotation vibration compensation control according to the third embodiment. As illustrated in FIG. 12, if the rotation vibration compensation controller 58 in the MPU 26 determines that the control is the on-track control after the completion of seeking to the target track at S21, the rotation vibration compensation controller 58 reads the rotation vibration detection data by sampling of the ADC 72 as the first ADC at S22, subtracts the rotation vibration detection data read from the head position control data, and performs the compensation control for eliminating the rotation vibration applied to the rotary actuator 25 at S23. This is the same as described in the first embodiment.

Next, at S24, the rotation vibration compensation controller 58 determines whether the off-track error is generated with respect to the head position signal. If the off-track error is generated during the on-track control, the process proceeds to S5, reads the vibration detection data (V_{SS1}) sampled by the ADC 98 as the second ADC, and calculates the translational vibration component (V_{SS1}+V_{SS2}) at S26.

From the calculation result, if the translational vibration component exists at S27, at S28, in the third embodiment, first, after the rotation vibration detection data read by the sampling of the ADC 72 is reduced by the predetermined ratio, for example, the data is reduced to a half, and the compensation ratio to eliminate the rotation vibration disturbance is suppressed.

In the rotation vibration compensation control where the compensation ratio is reduced, when the off-track error of the head is generated at S29, at S30, the sampling of the ADC 72 is cut, and the rotation vibration compensation control is released. The process from S21 to S30 is repeated until the stop instruction is given at S31.

In the rotation vibration compensation process of FIG. 11, when the off-track error of the head is generated, first, the rotation vibration detection data is reduced to suppress the compensation ratio, and the rotation vibration compensation control is released when the off-track error is generated. However, when the off-track error is generated, the rotation vibration compensation control may be immediately released.

In the third embodiment, an example is described in which the transitional vibration component is detected and the ratio of the rotation vibration compensation control is suppressed or released in the case of the first embodiment. Similarly, in the case of the second embodiment, when the off-track error of the head is generated, it may be checked whether the translational vibration component exists, and the ratio of the rotation vibration compensation amount may be lowered or released if the translational vibration component is detected.

In the embodiments described above, shock sensor that generates a vibration detection signal according to the third-order differentiation of displacement is described as a vibration detector that detects the rotation vibration component of the one-axis direction. However, this is by way of example only and the rotation vibration component of the one-axis direction may be detected by an acceleration sensor.

In the embodiments described above, the case is described where a pair of shock sensors are arranged on a circuit board constituting a control board. However, this is by way of example only, and, for example, the shock sensors 54-1 and 54-2 may be arranged at positions having high rigidity at the rear side of the base 60 of FIG. 2. The shock sensors 54-1 and 54-2 may be provided at the arbitrary positions of the magnetic disk.

As set forth hereinabove, according to an embodiment of the invention, even if a pair of vibration detectors that detects rotation vibration components in a one-axis direction are provided, before AD conversion is performed, an analog operation circuit obtains the difference between vibration detection signals output from the vibration detectors used to compensate for rotation vibration disturbance applied to a rotary actuator and inputs it to an ADC. Accordingly, even if a pair of vibration detectors are provided, only one ADC suffices, and the cost and process time can be reduced.

Moreover, a signal proportional to a compensation signal of the rotation vibration disturbance from the vibration detection signals output from the vibration detectors is calculated before being subjected to AD conversion by differential amplification of the analog operation circuit. This enables high-speed process by the analog operation circuit. Further, the need of differential operation by an MPU is eliminated, which reduces the load on the MPU.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device comprising:
a rotary actuator configured to position a head with respect to a storage medium and cause the head to perform reading operation or writing operation;
a pair of vibration detectors located at positions on the storage device substantially on both sides of a rotation center of the rotary actuator, the vibration detectors configured to detect rotation vibration component of a one-axis direction and output a vibration detection signal;
an analog operation circuit configured to calculate a rotation vibration detection signal proportional to rotation vibration disturbance applied to the rotary actuator by differential amplification of the vibration detection signal from the vibration detectors and output the rotation vibration detection signal;
an analog-to-digital converter configured to convert the rotation vibration detection signal output from the analog operation circuit into a digital signal and output rotation vibration detection data; and
a rotation vibration compensation controller configured to control the rotation vibration disturbance applied to the rotary actuator to be eliminated based on the rotation vibration detection data output from the analog-to-digital converter.

2. The storage device of claim 1, wherein
the vibration detectors comprises a first vibration detector and a second vibration detector,
the analog operation circuit comprises
an operational amplifier of differential amplification type;
a first input resistor configured to be connected between output of the first vibration detector and a non-inverting input terminal of the operational amplifier;
a second input resistor configured to be connected between the non-inverting input terminal of the operational amplifier and a power line;
a third input resistor configured to be connected between output of the second vibration detector and an inverting input terminal of the operational amplifier; and
a feedback resistor configured to be connected between the inverting input terminal and an output terminal of the operational amplifier, and
the operational amplifier is configured to calculate the rotation vibration detection signal V_{ADC} as follows:
$${V}_{ADC} = \frac{{R}_{3} + {R}_{4}}{{R}_{1} + {R}_{2}} ( \frac{{R}_{2}}{{R}_{3}} {V}_{ss 1} - \frac{{R}_{4}}{{R}_{3}} {V}_{ss 2} )$$
where R1, R2, R3, and R4 are resistance values of the first input resistor, the second input resistor, the third input resistor, and the feedback resistor, respectively, V_{SS1} is the vibration detection signal from the first vibration detector, and V_{SS2} is the vibration detection signal from the second vibration detector.

3. The storage device of claim 2, wherein the analog operation circuit is configured to set the resistance values R1, R2, R3, and R4 of the first input resistor, the second input resistor, the third input resistor, and the feedback resistor such that the rotation vibration detection signal V_{DAC} output from the operational amplifier satisfies
$${V}_{ADC} = ( \frac{{V}_{ss 1}}{{r}_{1}} - \frac{{V}_{ss 2}}{{r}_{2}} )$$
where V_{SS1} is the vibration detection signal from the first vibration detector and V_{SS2} is the vibration detection signal from the second vibration detector when the rotation center and rotation vibration center of the rotary actuator match, and r₁ is a distance from the rotation vibration center of the rotary actuator to the first vibration detector and r₂ is a distance from the rotation vibration center of the rotary actuator to the second vibration detector.

4. The storage device of claim 1, further comprising a multiplication circuit between output of each of the vibration detectors and input of the analog operation circuit, the multiplication circuit configured to multiply the vibration detection signal from each of the vibration detectors by a predetermined adjustment gain set by the rotation vibration compensation controller, wherein
the analog operation circuit is configured to receive the vibration detection signal after multiplication from the multiplication circuit and calculate the rotation vibration detection signal.

5. The storage device of claim 1, wherein the analog-to-digital converter is a first analog-to-digital converter, the storage device further comprising:
a second analog-to-digital converter configured to convert the vibration detection signal received from one of the vibration detectors to a digital signal and output vibration detection data to the rotation vibration compensation controller, and wherein
when detecting a displacement error of the head during control to eliminate the rotation vibration disturbance applied to the rotary actuator based on the rotation vibration detection data from the first analog-to-digital converter, the rotation vibration compensation controller reads the vibration detection data output from the second analog-to-digital converter, and calculates translational vibration disturbance component based on the rotation vibration detection data read from the first analog-to-digital converter before the displacement error occurs, and
when the translational vibration disturbance component is obtained, the rotation vibration compensation controller cuts the rotation vibration detection data from the first analog-to-digital converter to stop compensation control or decreases the rotation vibration detection data to suppress a compensation ratio.

6. The storage device of claim 5, wherein the rotation vibration compensation controller is configured to calculate translational disturbance component (V_{SS1}+V_{SS2}) as addition data to the vibration detection signal from the vibration detectors by −(V_{SS1}−V_{SS2})+2×(V_{SS1}) regarding the rotation vibration detection data read from the first analog-to-digital converter as differential data (V_{SS1}−V_{SS2}) between detection signals output from the vibration detectors, respectively, based on the vibration detection data (V_{SS1}) read from the second analog-to-digital converter.

7. The storage device of claim 1, wherein the vibration detectors are shock sensors or acceleration sensors.

8. A control circuit in a device comprising a rotary actuator configured to position a head with respect to a storage medium and cause the head to perform reading operation or writing operation, the control circuit comprising:
a pair of vibration detectors located at positions on the device substantially on both sides of a rotation center of the rotary actuator, the vibration detectors configured to detect rotation vibration component of a one-axis direction and output a vibration detection signal;
an analog operation circuit configured to calculate a rotation vibration detection signal proportional to rotation vibration disturbance applied to the rotary actuator by differential amplification of the vibration detection signal from the vibration detectors and output the rotation vibration detection signal;
an analog-to-digital converter configured to convert the rotation vibration detection signal output from the analog operation circuit into a digital signal and output rotation vibration detection data; and
a rotation vibration compensation controller configured to control the rotation vibration disturbance applied to the rotary actuator to be eliminated based on the rotation vibration detection data output from the analog-to-digital converter.

9. The control circuit of claim 8, wherein
the vibration detectors comprises a first vibration detector and a second vibration detector,
the analog operation circuit comprises
an operational amplifier of differential amplification type;
a first input resistor configured to be connected between output of the first vibration detector and a non-inverting input terminal of the operational amplifier;
a second input resistor configured to be connected between the non-inverting input terminal of the operational amplifier and a power line;
a third input resistor configured to be connected between output of the second vibration detector and an inverting input terminal of the operational amplifier; and
a feedback resistor configured to be connected between the inverting input terminal and an output terminal of the operational amplifier, and
the operational amplifier is configured to calculate the rotation vibration detection signal V_{ADC} as follows:
$${V}_{ADC} = \frac{{R}_{3} + {R}_{4}}{{R}_{1} + {R}_{2}} ( \frac{{R}_{2}}{{R}_{3}} {V}_{ss 1} - \frac{{R}_{4}}{{R}_{3}} {V}_{ss 2} )$$
where R1, R2, R3, and R4 are resistance values of the first input resistor, the second input resistor, the third input resistor, and the feedback resistor, respectively, V_{SS1} is the vibration detection signal from the first vibration detector, and V_{SS2} is the vibration detection signal from the second vibration detector.

10. The control circuit of claim 9, wherein the analog operation circuit is configured to set the resistance values R1, R2, R3, and R4 of the first input resistor, the second input resistor, the third input resistor, and the feedback resistor such that the rotation vibration detection signal V_{DAC} output from the operational amplifier satisfies
$${V}_{ADC} = ( \frac{{V}_{ss 1}}{{r}_{1}} - \frac{{V}_{ss 2}}{{r}_{2}} )$$
where V_{SS1} is the vibration detection signal from the first vibration detector and V_{SS2} is the vibration detection signal from the second vibration detector when the rotation center and rotation vibration center of the rotary actuator match, and r₁ is a distance from the rotation vibration center of the rotary actuator to the first vibration detector and r₂ is a distance from the rotation vibration center of the rotary actuator to the second vibration detector.

11. The control circuit of claim 8, further comprising a multiplication circuit between output of each of the vibration detectors and input of the analog operation circuit, the multiplication circuit configured to multiply the vibration detection signal from each of the vibration detectors by a predetermined adjustment gain set by the rotation vibration compensation controller, wherein
the analog operation circuit is configured to receive the vibration detection signal after multiplication from the multiplication circuit and calculate the rotation vibration detection signal.

12. The control circuit of claim 8, wherein the analog-to-digital converter is a first analog-to-digital converter, the storage device further comprising:
a second analog-to-digital converter configured to convert the vibration detection signal received from one of the vibration detectors to a digital signal and output vibration detection data to the rotation vibration compensation controller, and wherein
when detecting a displacement error of the head during control to eliminate the rotation vibration disturbance applied to the rotary actuator based on the rotation vibration detection data from the first analog-to-digital converter, the rotation vibration compensation controller reads the vibration detection data output from the second analog-to-digital converter, and calculates translational vibration disturbance component based on the rotation vibration detection data read from the first analog-to-digital converter before the displacement error occurs, and
when the translational vibration disturbance component is obtained, the rotation vibration compensation controller cuts the rotation vibration detection data from the first analog-to-digital converter to stop compensation control or decreases the rotation vibration detection data to suppress a compensation ratio.

13. The control circuit of claim 12, wherein the rotation vibration compensation controller is configured to calculate translational disturbance component (V_{SS1}+V_{SS2}) as addition data to the vibration detection signal from the vibration detectors by −(V_{SS1}−V_{SS2})+2×(V_{SS1}) regarding the rotation vibration detection data read from the first analog-to-digital converter as differential data (V_{SS1}−V_{SS2}) between detection signals output from the vibration detectors, respectively, based on the vibration detection data (V_{SS1}) read from the second analog-to-digital converter.

14. The control circuit of claim 8, wherein the vibration detectors are shock sensors or acceleration sensors.
